(19) United States
(12) Patent Application Publication
(10) Pub. No.: US 2006/0260556 A1
(43) Pub. Date: Nov. 23, 2006

(54) Printed disposable animal training pad

(76) Inventor: Jack W. Renforth, Aurora, CO (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(21) Appl. No.: 11/190,355

(22) Filed: Jul. 26, 2005

Related U.S. Application Data
(60) Provisional application No. 60/684,241, filed on May 23, 2005.

(51) Int. Cl. A01K 29/00

(52) U.S. Cl. 119/169

(57) ABSTRACT

A disposable animal training pad having a top layer, a bottom layer attached to the top layer, a middle layer between the top and bottom layers, and a graphic visible from a top of the pad. The graphic may be printed directly on the top layer, or may be printed on a layer sandwiched between the top and middle layers. Similarly, the graphic may be printed on the middle layer and the top layer may be transparent or translucent.

### CROSS-REFERENCE TO RELATED APPLICATIONS

This application claims the benefit under 35 U.S.C. § 119(e) of provisional patent application no. 60/684,241, filed on May 23, 2005 and entitled “Printed Disposable Animal Training Pad”, the disclosure of which is hereby incorporated herein in its entirety.

### BACKGROUND OF THE INVENTION

1. Technical Field

The present invention relates generally to animal training products, and more specifically to a disposable pad for absorbing animal waste products.

2. Background Art

Animal training pads have gained popularity as a means to absorb wastes produced by a domestic animal, and encourage the animal to urinate only in a particular area. These training pads may be either reusable or disposable. Disposable pads, as discussed herein, are intended for limited use and may be made from non-washable fabrics. Disposable pads are typically thrown away after an animal uses them.

Many training pads, however, are aesthetically displeasing. Although functional, the pads are utilitarian in appearance and noticeable in an animal owner's residence. This is especially true of disposable pads, where the low cost of manufacture may prohibit providing any aesthetically pleasing features.

Accordingly, there is a need in the art for an improved animal training pad.

### BRIEF SUMMARY OF THE INVENTION

One embodiment of the present invention takes the form of a disposable animal training pad having a top layer, a bottom layer attached to the top layer, a middle layer between the top and bottom layers, and a graphic visible from a top of the pad. The graphic may be printed directly on the top layer, or may be printed on a layer sandwiched between the top and middle layers. Similarly, the graphic may be printed on the middle layer and the top layer may be transparent or translucent.

The top layer of the pad is typically moisture-permeable or liquid-permeable. The middle layer is moisture-absorbent, and the bottom layer is moisture-impermeable. The layers may be constructed from any suitable material or combination of materials. For example, the top layer may be paper having a backing preventing liquid from exiting the middle layer.

Additional features and advantages of the present invention will become apparent upon reading the entirety of this disclosure.

### BRIEF DESCRIPTION OF THE FIGURES

FIG. 1 depicts a top view of a first embodiment of the present invention.

FIG. 2 depicts a cross-sectional view of the embodiment of FIG. 1.

FIG. 3 depicts an exemplary pattern printed on the embodiment of FIGS. 1 and 2.

FIG. 4 depicts a second exemplary pattern printed on the embodiment of FIGS. 1 and 2.

FIG. 5 depicts a third exemplary pattern printed on the embodiment of FIGS. 1 and 2.

FIG. 6 depicts a fourth exemplary pattern printed on the embodiment of FIGS. 1 and 2.

FIG. 7 depicts a fifth exemplary pattern printed on the embodiment of FIGS. 1 and 2.

FIG. 8 depicts a sixth exemplary pattern printed on the embodiment of FIGS. 1 and 2.

FIG. 9 depicts a seventh exemplary pattern printed on the embodiment of FIGS. 1 and 2.

Fig. 10 depicts an eighth exemplary pattern printed on the embodiment of FIGS. 1 and 2.

### DETAILED DESCRIPTION

One embodiment of the present invention takes the form of an object (such as a pad) for absorbing waste products, such as urine, produced by a domestic animal. The pad may be placed on a floor or other convenient surface where the domestic animal urinates. The pad absorbs the waste product and typically prevents the waste from contacting the surface beneath the pad.

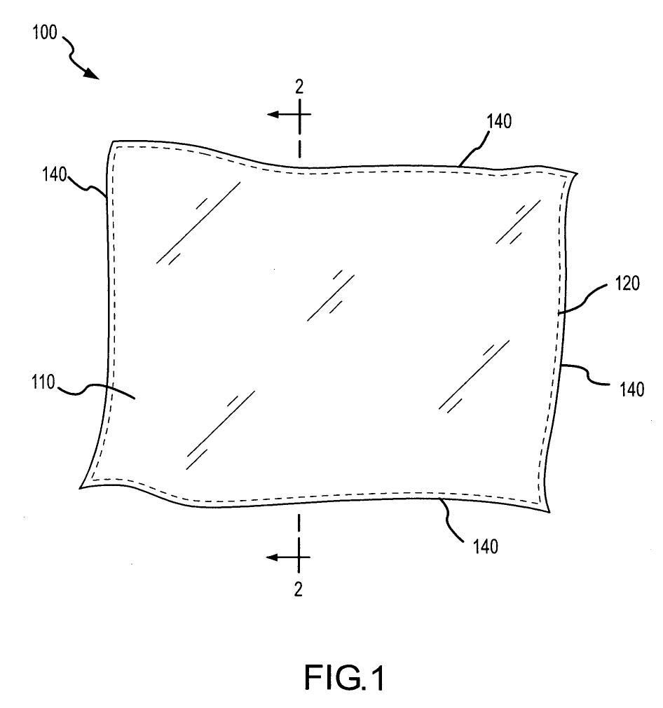

FIG. 1 displays an exemplary pad 100. The pad 100 consists of a top 110, middle 120, and bottom layer (not shown). The top layer 110 is typically moisture-permeable. The middle layer 120 is moisture-absorbent, and the bottom layer (not shown) is moisture-impermeable. In this manner, urine or other liquids may pass through the top layer 110, be absorbed by the middle layer 120, and prevented from contacting the surface below the pad. Dashed lines depicts the middle layer 120 located beneath the top layer 110. Typically, the middle layer 120 is not visible to an observer, but alternative embodiments may construct the top layer 110 from an at least partially transparent or translucent material to allow the observer to see the middle layer 120. Additionally, it should be noted the middle layer 120 often extends to the very edge 140 of the pad 100. Thus, in some embodiments, the dashed lines would underlie the edge 140 of the pad 100. The dashed lines are shown in their current location for illustrative purposes only; the exact location of the middle layer 120 may vary in alternative embodiments of the invention. For example, in certain embodiments the top 110 and bottom layers may be sealed or affixed to one another, such as with an adhesive or by heat sealing, to form a border. In such embodiments, the middle layer 120 may not extend to the very edge 140 of the pad 110. In alternative embodiments, only the very edges 140 (and possibly only the outer edges) of the top 110 and bottom layers may be affixed to one another. This allows the middle layer 120 to extend across substantially the entire pad surface.

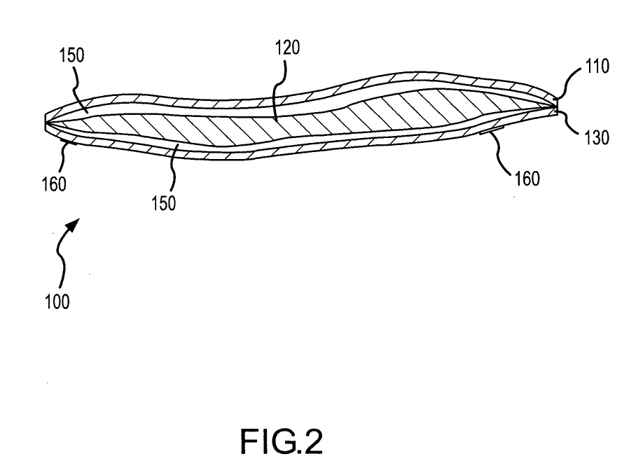

FIG. 2 depicts a cross-sectional view of the pad of FIG. 1, taken along line 2-2 of FIG. 1. The cross-sectional view depicts the top 110, middle 120, and bottom 130 layers of the pad 100. The top and bottom 130 layers define an interior cavity 150 within the pad 100, in which the middle layer 120 resides. The middle layer 120 may fill the entire cavity 150, or may fill only a portion of the cavity 150. The pad 100 is shown in FIG. 2 with only the outer edges of the top 110 and bottom 130 layers sealed together. As mentioned above, a portion of the interior surfaces of the top and bottom layers may be sealed to one another.

A variety of materials may be used to construct the top 110, middle 120, and bottom 130 layers of the pad 100. All that is required is that the top layer 110 be at least partially moisture-permeable, the middle layer 120 at least partially moisture-absorbent, and the bottom layer 130 moisture-impermeable. Thus, for example, the top layer 110 may be formed from an appropriate synthetic or natural fabric permitting urine to pass therethrough, the middle layer 120 from an appropriately absorptive material such as a polymer, and the bottom layer 130 from a moisture barrier such as a plastic. Any or all of these layers may be made from a paper, so long as the paper has the appropriate characteristics discussed above. For example, the layers may be constructed from a paper impregnated or coated with an appropriate agent to render the layer absorbent or moisture-impermeable, as necessary. Those of ordinary skill in the art will appreciate the variety of fabrics and materials from which each layer may be constructed.

One or more of the layers may be coated or impregnated with a pheromone to attract the animal and encourage it to urinate on the pad 100, as opposed to on an owner's rug, floor, or other surface. The pheromone may, for example, be secreted or impregnated within the middle layer 130. This prevents the pheromone from rubbing off or dissipating as the exterior layers are touched or rubbed. It should be noted, however, that the top 110 and/or bottom 130 layers may similarly be impregnated with a pheromone.

The present embodiment additionally may include one or more contact points 160 on the bottom 130 layer's exterior designed to prevent the embodiment from moving once placed on a surface. These contact points 160 may be an adhesive, tape, rubber foot, and so forth. The contact points 160 may not only prevent the pad 100 from sliding or moving, but may also protect the surface on which the pad 100 is placed.

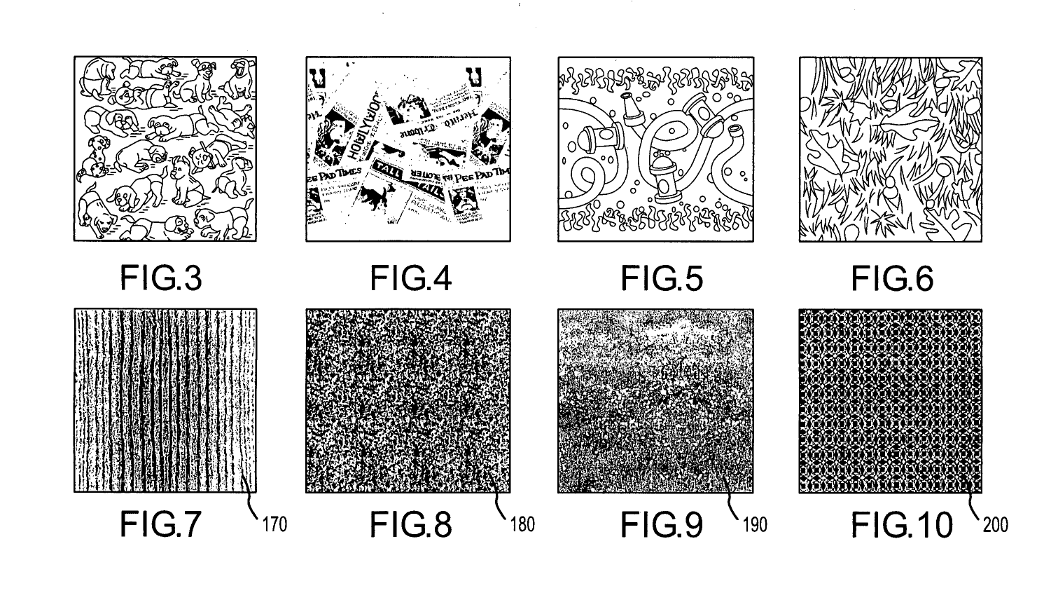

Additionally, the pad 100 may be aesthetically pleasing to a potential consumer and/or pet owner. The top surface 110 (i.e., top layer) of the pad 100 may be printed with a design, picture, or motif (“graphic”). In this manner, the pad 100 is less obtrusive when placed in an animal owner's home. FIGS. 3 through 10 depict exemplary graphics that may be printed on the pad 100.

As shown in FIG. 7, the printed surface of the pad 100 may be made to match a surface commonly occurring in a home. FIG. 7, for example, shows the pad 100 printed with a woodgrain graphic 170. Similarly, the pad 100 may be printed to resemble a flooring tile, carpet, or rug. By matching the graphic 170 on the pad's top layer 110 to the pattern of the surface on which the pad rests, the pad 100 may be rendered even less obtrusive in an animal owner's home. Alternate embodiments of the invention may include patterns or graphics 180, 190, 200 as shown in FIGS. 7-10.

The pattern or design 170 may be placed on the pad 100 in a variety of ways. For example, the graphic 170 may be silk-screened, pad printed, screen printed, digitally printed, laser printed, inkjet printed, and so forth onto the top layer 110. Similarly, the pattern may be woven into the fabric of the top layer 110. Typically, however, the pattern or graphic is printed onto the top layer 110. The various printing techniques and methods known to those skilled in the art may all be employed to create the image 170 on the top layer 110 of the pad 100.

Alternative embodiments may construct the top layer 100 from a transparent or translucent material, and place the image 170 on the middle layer 120 of the pad 100. Yet other embodiments may employ a transparent or translucent top layer 110, and place the image on a moisture-permeable or water-permeable layer located between the top and middle 120 layers. Effectively, in such embodiments the image 170 is placed in its own layer of the pad 100.

Although the top layer 110 has been described herein as moisture-permeable or water-permeable, it should be understood that certain embodiments of the invention may employ a material that allows moisture or liquids to pass through only in one direction. In such embodiments, the liquid is effectively trapped between the top 110 and bottom 130 layers once it enters the cavity 150. This may facilitate absorption of the liquid by the middle layer 120 and keep an animal resting, sitting, or standing on the top layer 110 relatively dry.

Additionally, the various embodiments described herein are generally disposable after use. That is, the pad 100 is designed to be discarded, rather than washed and/or cleaned for another use. Accordingly, any and all layers may be made from a non-washable material. Further, the pad 100 typically does not include any anti-microbial agent since the pad is discarded; the growth of microbes or bacteria are irrelevant once the pad is disposed. Some embodiments of the present invention may include an anti-microbial agent.

Although the present invention has been discussed with respect to specific embodiments, those of ordinary skill in the art will appreciate that additional embodiments may be realized upon review of the foregoing disclosure. Similarly, certain changes to the various embodiments described herein may occur to those of ordinary skill in the art upon reading the disclosure. Accordingly, the proper scope of the invention is defined by the appended claims.

We claim:

1. An animal training pad, comprising:
a top layer;
a bottom layer attached to the top layer;
a middle layer between the top and bottom layers;
a graphic visible from a top of the pad; wherein
the animal training pad is operative to be disposed after a single use.

2. The animal training pad of claim 1, wherein at least one of the top, bottom, and middle layers is made from a non-washable material.

3. The animal training pad of claim 1, wherein the graphic matches a flooring surface.

4. The animal training pad of claim 1, wherein the middle layer is moisture-absorbent.

5. The animal training pad of claim 4, wherein the top layer is moisture-permeable.

6. The animal training pad of claim 5, wherein the bottom layer is moisture-impermeable.

7. The animal training pad of claim 6, wherein the middle layer comprises a polymer.

8. The animal training pad of claim 7, wherein the bottom layer comprises a plastic.

9. The animal training pad of claim 8, further comprising at least one contact point, the at least one contact point at least partially preventing movement of the pad when the bottom layer is placed in contact with a support surface.

10. The animal training pad of claim 9, wherein the at least one contact point is an adhesive.

11. The animal training pad of claim 9, wherein the at least one contact point is a tape.

12. The animal training pad of claim 8, wherein the graphic is printed on the top layer.

13. The animal training pad of claim 12, wherein the graphic is pad-printed on the top layer.

14. The animal training pad of claim 12, wherein the graphic is screened on the top layer.

15. The animal training pad of claim 12, wherein the graphic is woven into the top layer.

16. The animal training pad of claim 8, wherein:
the graphic is printed on a graphic layer between the top layer and middle layer; and
the top layer is transparent.

17. The animal training pad of claim 8, wherein at least one of the top, bottom, and middle layers at least partially comprises a paper.
